(19) United States
(12) Patent Application Publication
(10) Pub. No.: US 2026/0235278 A1
(43) Pub. Date: Aug. 13, 2026

(54) LIGHT FIXTURE COUPLER FOR EXCHANGING LAMPSHADE WITHOUT DISASSEMBLING ELECTRICAL COMPONENTS

(71) Applicant: Design and Deliver, LLC dba Lux Lampshades, Charlotte, NC (US)

(72) Inventors: Robert Jones, Charlotte, NC (US); Douglas Cohen, Lyndhurst, OH (US); Tyra Bulson, Solon, OH (US); Jonathan Guyton, Opelika, AL (US); Elizabeth Keller, Lakewood, OH (US); Robert Grobolsek, Sheffield Village, OH (US); Robert Halper, Chagrin Falls, OH (US)

(73) Assignee: Design and Deliver, LLC dba Lux Lampshades, Charlotte, NC (US)

(21) Appl. No.: 19/264,624

(22) Filed: Jul. 9, 2025

Related U.S. Application Data
(60) Provisional application No. 63/758,165, filed on Feb. 13, 2025.

(51) Int. Cl. F21V 17/00; F21V 23/00

(52) U.S. Cl. CPC F21V 17/002; F21V 23/001

(57) ABSTRACT

Coupling components and systems for light fixtures. A device includes a base comprising, wherein the base includes a base platform, and a base sidewall attached to the base platform, wherein the base sidewall is perpendicular to the base platform within a tolerance of ten percent. The base of the device includes a spider rod channel formed in the base sidewall, wherein the spider rod channel defines a negative space configured to receive a spider rod of a spider fitter of a lampshade. The device includes a conduit arm attached to the base, wherein the conduit arm comprises a conduit sidewall defining a hollow interior. The device is such that the hollow interior of the conduit arm is configured to receive an electrical wire of a light fixture.

### TECHNICAL FIELD

The present disclosure relates generally to couplers and more specifically to couplers for use in connection with light fixtures.

### BACKGROUND

Lampshades are commonly used to soften harsh direct light, reduce glare, and create a comfortable ambiance with even light distribution. Many designers utilize lampshades to add color, texture, and pattern to a space, and to create visual interest that may complement or contrast with other décor. Lampshades are used in connection with many types of light fixtures, including pendants, floor lamps, table lamps, chandeliers, ceiling-mounted fixtures, and sconces.

In some cases, a user may wish to convert an existing lampshade into a hanging light fixture. The hanging light fixture may include a ceiling-mounted fixture, a wall-mounted fixture with an arm, or a freestanding lamp with an arm. Conventional light fixture systems do not include customizable hardware for creating a custom hanging light fixture with an existing lampshade. In these cases, the user may be forced to buy a different light fixture or seek out expensive custom hardware that will work with the existing lampshade.

Additionally, in some cases, a user may wish to quickly exchange a lampshade to update the light fixture with existing décor, rotate design choices based upon the season, or change how the light fixture distributes light. However, depending on the type of light fixture, the user may need to disconnect electrical wiring prior to removing the existing lampshade and installing a new lampshade. This can be a time consuming process that may not be intuitive for all users.

What is needed are systems, methods, and devices for converting a lampshade into a hanging light fixture. Further what is needed are systems, methods, and devices for exchanging a lampshade without disassembling a light fixture or disconnecting electrical components within the light fixture. Such systems, methods, and devices would provide a user-friendly means to quickly exchange lampshades based on style preferences, seasons, and occasions.

In view of the foregoing, described herein are systems, methods, and devices for utilizing a lampshade in connection with a light fixture.

### BRIEF DESCRIPTIONS OF THE DRAWINGS

Non-limiting and non-exhaustive implementations of the disclosure are described with reference to the following figures, wherein like reference numerals refer to like parts throughout the various views unless otherwise specified. Advantages of the disclosure will become better understood with regard to the following description and accompanying drawings where:

FIG. 1 is a schematic illustration of a cross-sectional view of a light fixture that includes a coupler for releasably coupling a lampshade to a lighting component such that a user may exchange the lampshade without disconnecting electrical components of the light fixture;

FIG. 2 is a schematic illustration of a cross-sectional view of a coupler for a light fixture that enables a lampshade of the light fixture to be removed without disconnecting electrical components of the light fixture;

FIG. 3 is a perspective view of a coupler for a light fixture that enables a lampshade of the light fixture to be removed without disconnecting electrical components of the light fixture, and further enables the lampshade to be converted into a hanging light fixture;

FIG. 4 is a wireframe aerial top-down view of a coupler for a light fixture that enables a lampshade of the light fixture to be removed without disconnecting electrical components of the light fixture, and further enables the lampshade to be converted into a hanging light fixture;

FIG. 5 is a straight-on side view of a coupler for a light fixture that enables a lampshade of the light fixture to be removed without disconnecting electrical components of the light fixture, and further enables the lampshade to be converted into a hanging light fixture;

FIG. 6 is a straight-on side view of a coupler for a light fixture that enables a lampshade of the light fixture to be removed without disconnecting electrical components of the light fixture, and further enables the lampshade to be converted into a hanging light fixture;

FIG. 7 is a perspective view of a coupler for a light fixture that enables a lampshade of the light fixture to be removed without disconnecting electrical components of the light fixture, and further enables the lampshade to be converted into a hanging light fixture;

FIG. 8 is a perspective view of a coupler for a light fixture that enables a lampshade of the light fixture to be removed without disconnecting electrical components of the light fixture, and further enables the lampshade to be converted into a hanging light fixture;

FIG. 9 is a perspective view of a coupler for a light fixture that enables a lampshade of the light fixture to be removed without disconnecting electrical components of the light fixture, and further enables the lampshade to be converted into a hanging light fixture;

FIG. 10 is a perspective view of a coupler for a light fixture that enables a lampshade of the light fixture to be removed without disconnecting electrical components of the light fixture, and further enables the lampshade to be converted into a hanging light fixture;

FIG. 11 is a straight-on side view of a coupler for a light fixture that enables a lampshade of the light fixture to be removed without disconnecting electrical components of the light fixture, and further enables the lampshade to be converted into a hanging light fixture;

FIG. 12 is a wireframe aerial top-down view of a coupler for a light fixture that enables a lampshade of the light fixture to be removed without disconnecting electrical components of the light fixture, and further enables the lampshade to be converted into a hanging light fixture;

FIG. 13 is a wireframe straight-on side view of a coupler for a light fixture that enables a lampshade of the light fixture to be removed without disconnecting electrical components of the light fixture, and further enables the lampshade to be converted into a hanging light fixture;

FIG. 14 is a perspective view of a coupler for a light fixture that enables a lampshade of the light fixture to be removed without disconnecting electrical components of the light fixture, and further enables the lampshade to be converted into a hanging light fixture;

FIG. 15 is a perspective view of a coupler for a light fixture that enables a lampshade of the light fixture to be removed without disconnecting electrical components of the light fixture, and further enables the lampshade to be converted into a hanging light fixture;

FIG. 16 is an aerial top-down view of a coupler for a light fixture that enables a lampshade of the light fixture to be removed without disconnecting electrical components of the light fixture, and further enables the lampshade to be converted into a hanging light fixture;

FIG. 17 is a cross-sectional straight-on side view of a coupler for a light fixture that enables a lampshade of the light fixture to be removed without disconnecting electrical components of the light fixture, and further enables the lampshade to be converted into a hanging light fixture;

FIG. 18 is a schematic illustration of a system for exchanging a lampshade of a light fixture without disassembling electrical components of the light fixture;

FIG. 19 is a perspective view of a coupler for a light fixture that enables a lampshade of the light fixture to be removed without disconnecting electrical components of the light fixture, and further enables the lampshade to be converted into a hanging light fixture;

FIG. 20 is an aerial top-down view of a coupler for a light fixture that enables a lampshade of the light fixture to be removed without disconnecting electrical components of the light fixture, and further enables the lampshade to be converted into a hanging light fixture;

FIG. 21 is a schematic illustration of an aerial top-down view of a spider fitter of a lampshade; and

FIG. 22 is a schematic illustration of an aerial top-down view of a spider fitter of a lampshade.

### DETAILED DESCRIPTION

Described herein are systems, methods, and devices for converting a lampshade into a custom hanging light fixture, and further for exchanging a lampshade of a light fixture without disassembling electrical components for the light fixture. The systems, methods, and devices described herein may be utilized in connection with various types of light fixtures, including, for example, pendants, chandeliers, sconces, floor lamps, and table lamps.

The systems, methods, and devices described herein may be utilized in connection with any lampshade that comprises a suitable fitting. The coupling systems and devices described herein are “generic” devices that may be utilized with an off-the-rack lampshade to convert the lampshade into a light fixture. A user may install one of the couplers described herein into an existing lampshade to convert the lampshade into a hanging light fixture that may be utilized as a standalone pendant or may be incorporated into a chandelier, sconce, floor lamp, table lamp, or other light fixture.

Specifically described herein is a system comprising a lampshade and a coupler. The lampshade may comprise a spider fitter, wherein the spider fitter includes a central ring, an outer ring, and a plurality of spider rods connecting the central ring to the outer ring. The coupler is configured to couple the lampshade to a hanging mount to manufacture a light fixture, wherein the light fixture may comprise any of a pendant, chandelier, sconce, floor lamp with hanging component, table lamp with hanging component, and so forth. The coupler includes a base and a conduit arm. The base of the coupler includes a base platform, and a base sidewall attached to the base platform, wherein the base sidewall is substantially perpendicular to the base platform. The base of the coupler further includes a spider rod channel formed in the base sidewall, wherein the spider rod channel defines a negative space configured to receive one of the plurality of spider rods of the spider fitter of the lampshade. The conduit arm of the coupler is attached to the base of the coupler. The conduit arm comprises a conduit sidewall that defines a hollow interior, wherein the hollow interior is configured to receive an electrical wire of the light fixture such that the electrical wire does not pass through the central ring of the lampshade or become otherwise entangled within or attached to the lampshade. This enables a user to remove the lampshade without disconnecting electrical components of the light fixture.

While numerous specific details are set forth in the following description to provide a thorough understanding of the systems, methods, and devices described herein, some implementations may be practiced without some or all disclosed details. Further, for the purpose of clarity, certain technical material that is known in the related art has not been described in detail to avoid unnecessarily obscuring the disclosure.

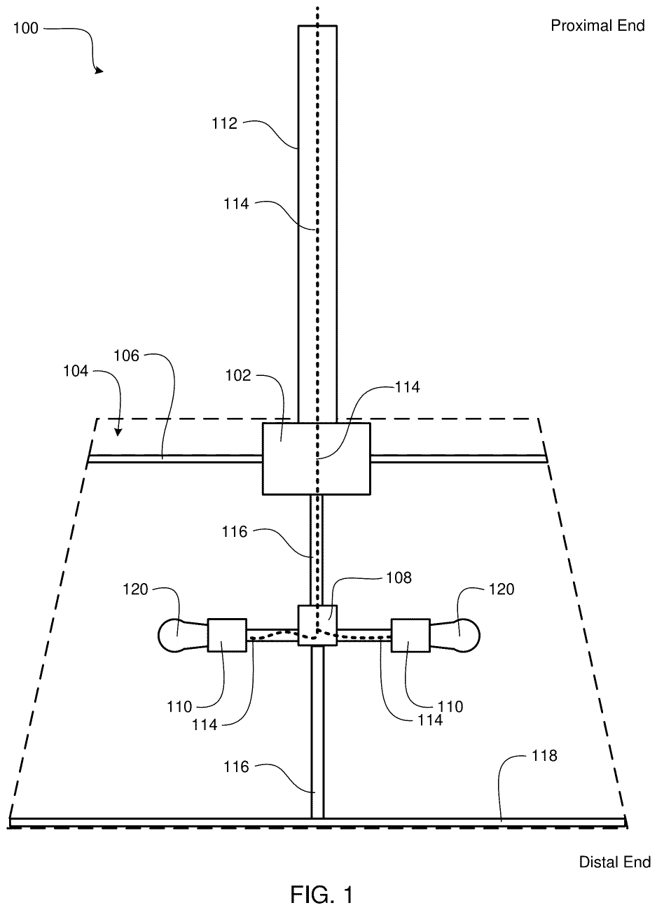

Referring now to the figures, FIG. 1 is a schematic cross-sectional illustration of a light fixture 100. The light fixture 100 may specifically include a hanging light fixture that features a hanging lampshade. The light fixture 100 may include, for example, a pendant, chandelier, floor lamp with a hanging lampshade, table lamp with a hanging lampshade, sconce with a hanging lampshade, and so forth. The light fixture 100 may include a pendant or chandelier that is mounted to a ceiling. The light fixture 100 may include a sconce that is mounted to a vertical wall and includes a hanging component. The light fixture 100 may include a freestanding floor lamp or table lamp that includes a hanging component.

The light fixture 100 includes a coupler 102 that couples a lampshade 104 to a hanging mount 112. The coupler 102 enables a user to couple the lampshade 102 to the hanging mount 112, and thus convert the lampshade 104 into a hanging light fixture. The hanging mount 112 may be directly or indirectly attached to a ceiling, vertical wall, or freestanding light fixture such as a floor lamp or table lamp.

The coupler 102 further enables the user to easily exchange the lampshade 104 of the light fixture 100 without disassembling the light fixture 100 or disconnecting electrical components of the light fixture 100. The coupler 102 is a generic device that may be utilized with any lampshade comprising a suitable fitter.

The hanging mount 112 may include a rigid, compliant, or flexible mount. The hanging mount 112 may include a down-rod or stem of a pendant, chandelier, sconce, table lamp, floor lamp, and so forth. The hanging mount 112 may include a chain of a pendant, chandelier, sconce, table lamp, floor lamp, and so forth. The hanging mount 112 may include a rope or cord of a pendant, chandelier, sconce, table lamp, floor lamp, and so forth. The hanging mount 112 may be directly or indirectly fastened to a junction box installed within a ceiling or wall. The hanging mount 112 may be directly or indirectly fastened to other components of a light fixture, such as a rod or frame of a table lamp, floor lamp, or sconce.

The lampshade 104 includes a fitter 106. The fitter 106 includes one or more wires or other semi-rigid components for maintaining the shape of the lampshade 104 and attaching the lampshade 104 to other components of the light fixture. The fitter 106 may include a spider fitter comprising a central ring, an outer ring, and a plurality of spider rods extending from the central ring to the outer ring. The fitter 106 may include a four-rod spider fitter. The fitter 106 may include a three-rod spider fitter. The coupler 102 may be designed to be utilized with either of a four-rod spider fitter or a three-rod spider fitter.

The light fixture 100 optionally includes a light fixture component 108 that directly or indirectly facilitates electrical communication with one or more light sockets 110. The light fixture 100 includes one or more of the light sockets 110. The light fixture component 108 may include a cluster body that comprises a frame for holding a plurality of light sockets 110. The light fixture component 108 may facilitate electrical communication with one light socket 110, two light sockets 110, three light sockets 110, four light sockets 110, five light sockets 110, six light sockets 110, and so forth. The light fixture 100 may include one or more light fixture components 108 that each comprise a cluster body to facilitate electrical communication with a plurality of light sockets 110. Each of the plurality of light sockets 110 includes a receptable for receiving a light bulb 120.

The light fixture 100 includes an electrical wire 114. The electrical wire 114 initiates at an electrical source, which may include a junction box installed in a ceiling or wall or a plug intended to be plugged into an outlet. The electrical wire 114 passes through, adjacent to, or near the hanging mount 112. If the hanging mount 112 includes a down-rod or stem, then the electrical wire 114 may be fed through a hollow interior of the down-rod or stem. If the hanging mount 112 includes a chain, then the electrical wire 114 may be fed through links of the chain or wrapped around the chain. If the hanging mount 112 includes a rope, cord, or other fixture, then the electrical wire 114 may be wrapped around the hanging mount 112, disposed adjacent to the hanging mount 112, or located nearby the hanging mount 112.

The electrical wire 114 passes through the coupler 102 in a manner that bypasses entanglement with the fitter 106. If the fitter 106 is a spider fitter including a central ring, the electrical wire 114 passes through the coupler 102 in a manner that prevents the electrical wire 114 from passing through the central ring of the fitter 106. The coupler 102 thus enables a user to quickly remove and replace the lampshade 104 without disassembling or disconnecting electrical component of the light fixture 100.

The electrical wire 114 passes through the coupler 102 and then interfaces with the light fixture component 108 (if applicable) and one or more light sockets 110. The electrical wire 114 may thereby enable electricity to pass from the electrical source to the one or more lightbulbs installed within the one or more light sockets.

The light fixture 100 may include a down-rod 116 that attaches directly or indirectly to the coupler 102. The light fixture component 108 and/or light socket(s) 110 may be attached directly or indirectly to the down-rod 116. The down-rod 116 may extend downward past the light fixture component 108 and/or light socket(s) 110 as shown in FIG. 1. In this case, the light fixture 100 may include a diffuser 118 attached to the down-rod 116.

The diffuser 118 is configured to be utilized in connection with the lampshade 104, and the size of the diffuser 118 may be optimized depending upon the size of the lampshade 104. The diffuser 118 is constructed of a suitable material to diffuse light output by the one or more light bulbs 120 and thus provide a soft ambient light from the light fixture 100. The diffuser 118 may comprise a substantially flat piece of material configured to be disposed at a distal end of the lampshade 104 and/or disposed within an interior space defined by the lampshade 104. The diffuser 118 may be attached to the down-rod 116 such that the diffuser 118 is not directly attached to the lampshade 104.

The diffuser 118 may be constructed of any suitable diffusing material, such as for example, frosted plexiglass, frosted acrylic, polycarbonate, rice paper, shoji paper, fabric, parchment paper, vellum, opal glass, frosted glass, HDPE, PETG, polypropylene, tracing paper, vinyl, and so forth.

The lampshade 104 may comprise a circular cross-sectional geometry at the distal end of the lampshade 104 that comprises a diameter, and in this case, the diffuser 118 may likewise have a circular geometry with the same diameter, or a slightly shorter diameter, to enable the diffuser 118 to be disposed within the lampshade 104 at a distal end of the lampshade 104. The lampshade 104 may comprise a polygonal cross-sectional geometry at the distal end of the lampshade 104, and in this case, the diffuser 118 may likewise comprise the same polygonal geometry to enable the diffuser 118 to be disposed within the lampshade 104 at a distal end of the lampshade 104.

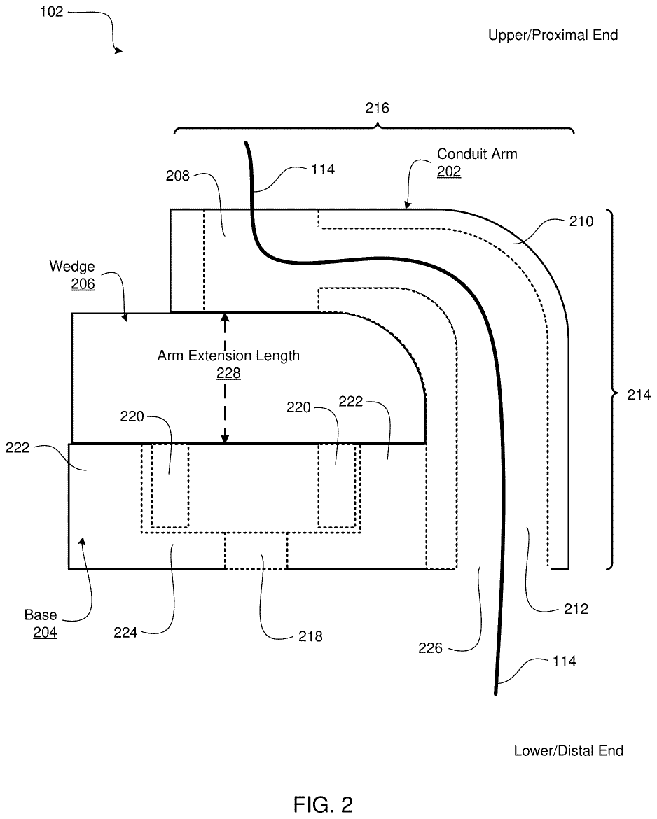

FIG. 2 is a schematic illustration of a cross-sectional straight-on side view of the coupler 102. The coupler 102 may be utilized to convert a lampshade (see 104 at FIG. 1) into a hanging light fixture (see 100 at FIG. 1). The coupler 102 further enables a user to conveniently exchange the lampshade 104 of any light fixture without disconnecting electrical components of the light fixture.

The coupler 102 includes a conduit arm 202 and a base 204. The coupler 102 includes a wedge 206 disposed in between the conduit arm 202 and the base 204. The wedge 206 may slide in and out of place to enable a user to install or exchange the coupler 102. The wedge 206 may be attached to the base 204 by way of a pivot point that enables the wedge 206 to swing into and out of place. The conduit arm 202 and the base 204 may form a single indivisible component, or they may be permanently fastened to one another, or they may be releasably fastened to one another.

The conduit arm 202 includes a sidewall 210 defining a hollow interior 212. The conduit arm 208 includes an upper hole 208 disposed on an upper/proximal surface of the sidewall 210 (wherein the upper/proximal surface is facing upward when the coupler 102 is installed in a light fixture 100). The upper hole 208 may include internal threading configured to interface with a down-rod of a hanging light fixture. This enables a user to directly couple the coupler 102 to the down-rod of the hanging light fixture.

The electrical wire 114 passes through the upper hole 208 and into the hollow interior 212 of the conduit arm 202. The electrical wire 114 exits the conduit arm 202 through a lower hole 226 defined by the sidewall 210 of the conduit arm 202 (wherein the lower hole 226 opens downward when the coupler 102 is installed in a light fixture 100).

The base 204 includes a base platform 224 and a base sidewall 222 attached to the base platform 224. The base platform 224 may be oriented substantially parallel to a ground surface when the coupler 102 is installed in the light fixture 100. The base sidewall 222 is substantially perpendicular to the base platform 224. The base sidewall 222 may be perpendicular to the base platform 224 within a tolerance of ten percent, or within a tolerance of about one percent to about 20 percent. The base sidewall 222 includes a plurality of spider rod channels 220 cut into the base sidewall, wherein each of the spider rod channels 220 comprises a width configured to receive a spider rod of a fitter (see 106 at FIG. 1) of a lampshade (see 104 at FIG. 1). The base 204 includes a through-hole 218 disposed through the base platform 224. The through-hole 218 may include internal threading configured to interface with corresponding threading of a lighting component, such as a light socket 110 or another light fixture component 108.

The base sidewall 222 includes an upper surface that faces upward when the coupler 102 is installed within a light fixture 102. The conduit arm 202 includes a lower surface that faces downward when the coupler 102 is installed within the light fixture 102. The distance between the upper surface of the base sidewall 222 and the lower surface of the conduit arm 202 may be referred to as the arm extension length 228. The arm extension length 228 may be greater than a height of a central ring of a fitter 106 of a lampshade 104. This enables a user to easily slide the central ring of the fitter 106 in between the base 204 and the conduit arm 202, and then install the central ring within the base 202 such that the central ring rests on the base platform 224 and the spider rods are disposed through the spider rod channels 220 cut into the base sidewall 222. The arm extension length 228 may be substantially equal to a height of the wedge 206 within a tolerance threshold of about 20 percent.

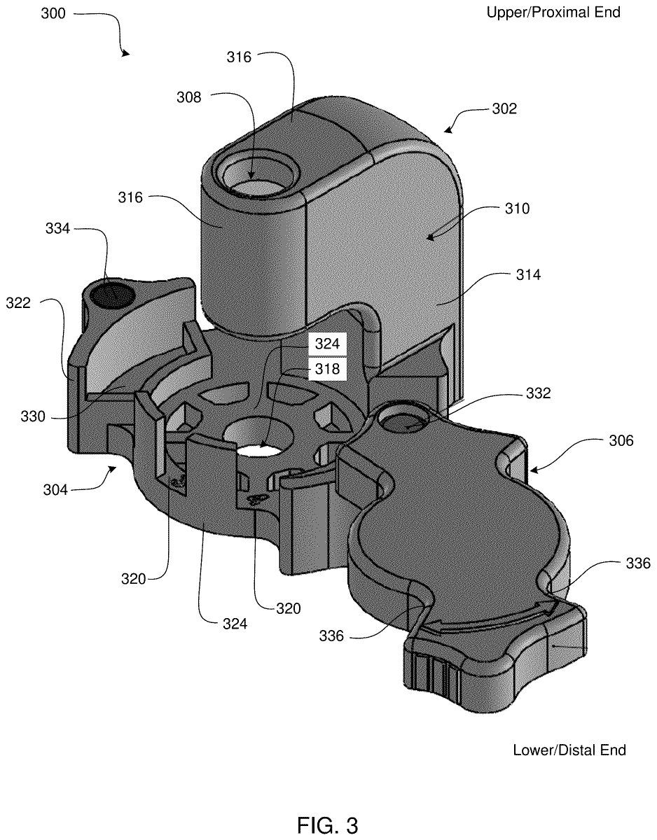

FIG. 3 is a perspective view of a coupler 300 for coupling a lampshade to a light fixture. The coupler 300 enables a user to convert a lampshade into a hanging light fixture as described herein. The coupler 300 further enables a user to exchange the lampshade without disassembling electrical components of the light fixture. The coupler 300 may be utilized in connection with the exemplary light fixture 100 first described in connection with FIG. 1.

The coupler 300 includes a conduit arm 302 coupled to a base 304, and further includes a wedge 306. The conduit arm 302 and the base 304 may form a singular indivisible component as shown in FIG. 3. Alternatively, the conduit arm 302 and the base 304 may be releasably coupled to one another or may be permanently fastened to one another.

The conduit arm 302 includes a sidewall 310 that defines a hollow interior (not shown in FIG. 3, see hollow interior 212 at FIG. 2). The sidewall 310 includes a conduit vertical sidewall 314 and a conduit bend sidewall 316. The conduit bend sidewall 316 is attached to the conduit vertical sidewall 314. The conduit bend sidewall 316 is oriented substantially perpendicular to the conduit vertical sidewall 314 within a manufacturing tolerance of about ten percent, or within a manufacturing tolerance from about one percent to about 20 percent. The hollow interior defined by the sidewall 310 of the conduit arm 202 is configured to receive the electrical wire (see 114 at FIG. 1) of a light fixture (see 100 at FIG. 1).

The conduit arm 302 includes an upper hole 308 disposed through the conduit bend sidewall 316. The upper hole 308 is located on an upper side of the sidewall 310 of the conduit arm 302 when the coupler 300 is installed within the light fixture 100. The upper hole 308 may include internal threading configured to interface with corresponding external threading of a down-rod of a hanging light fixture.

The conduit arm 302 additionally includes a lower hole (not visible in FIG. 3, see, e.g. lower hole 226 at FIG. 2) formed by the sidewall 310 of the conduit arm 302. The hollow interior defined by the sidewall 310 of the conduit arm 302 extends at least from the upper hole 308 to the lower hole (not visible). This enables a user to feed the electrical wire (see 114 at FIG. 1) into the hollow interior of the conduit arm 302 through the upper hole 308 and out through the lower hole, or vice versa.

The base 304 includes a base sidewall 322 attached to a base platform 324. The base sidewall 322 comprises a plurality of spider rod channels 320 formed into an upper ridge of the base sidewall 322. Each of the plurality of spider rod channels 320 is configured to receive a spider rod of a fitter (see 106 at FIG. 1) of a lampshade 104.

The coupler 300 includes a pivot point 332 for coupling the wedge 306 to the base 304. The pivot point 332 may include a hole disposed through the wedge 306, a corresponding blind hole disposed through the base 304, and a pivot rod disposed through the corresponding holes. The pivot point 332 enables the wedge 306 to swing into a closed position, wherein the wedge is disposed in between the base 304 and the conduit bend sidewall 316. The pivot point 332 further enables the wedge 306 to swing outward into an open position, as shown in FIG. 3. The wedge 306 may include grooves 336 formed in the geometry of the wedge 306 to enable a user to more easily grip on to the wedge to swing the wedge 306 into and out of position.

The base platform 324 is configured to receive a central ring of a fitter 106 of a lampshade 104. The base sidewall 322 includes the plurality of spider rod channels 320 to accommodate a lampshade 104 with a spider fitter. If the lampshade 104 includes the spider fitter, then the central ring of the spider fitter may rest on the base platform 324, and the plurality of spider rods of the spider fitter may rest within the plurality of spider rod channels 320.

The base platform 324 may be oriented substantially parallel to a ground surface when the coupler 300 is installed within a light fixture 100. The base sidewall 322 is oriented substantially perpendicular to the base platform 324 and may be oriented perpendicular to the base platform 324 within a tolerance of about ten percent or within a tolerance from about one percent to about 20 percent.

The base 304 includes a through-hole 318 disposed through the base platform 324. The through-hole may include internal threading configured to interface with corresponding external threading of a light fixture component (see, e.g., 108 at FIG. 1) or socket (see, e.g., 110 at FIG. 1).

The base 304 includes a wedge receptacle 330 carved into the base platform 324. The wedge receptacle 330 is configured to receive a corresponding piece of the wedge 306 (not visible in FIG. 3) to aid a user in properly lining up the wedge 306. The base 304 may further include a base magnet 334 configured to form a magnetic coupling with a corresponding wedge magnet that is located on a lower/distal side of the wedge 306 (not visible in FIG. 3). The coupling between the base magnet 334 and the wedge magnet (not shown) aids in ensuring the wedge 306 remains installed in between the base 304 and the conduit bend sidewall 316.

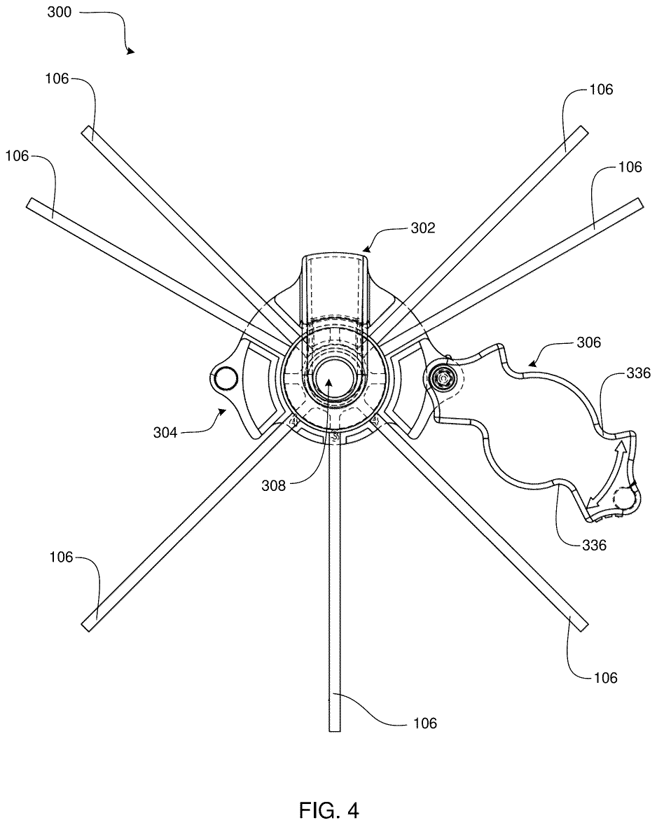

FIG. 4 is a perspective view of the coupler 300 that enables a user to convert a lampshade into a hanging light fixture, and further enables the user to exchange a lampshade of a light fixture without disassembling electrical components of the light fixture. In FIG. 4, the wedge 306 is swung about the pivot point 332 such that the wedge 306 is not disposed in between the base 304 and the conduit arm 302. In contrast with the view illustrated in FIG. 3, the view in FIG. 4 additionally illustrates components of a fitter (see 106 at FIG. 1) of a lampshade (see 104 at FIG. 1).

The base 304 includes the plurality of spider rod channels 320 cut into the base sidewall 322. As shown in FIG. 4, the spider rod channels 320 define an empty or negative space configured to receive a spider rod of a fitter 106 of a lampshade 104.

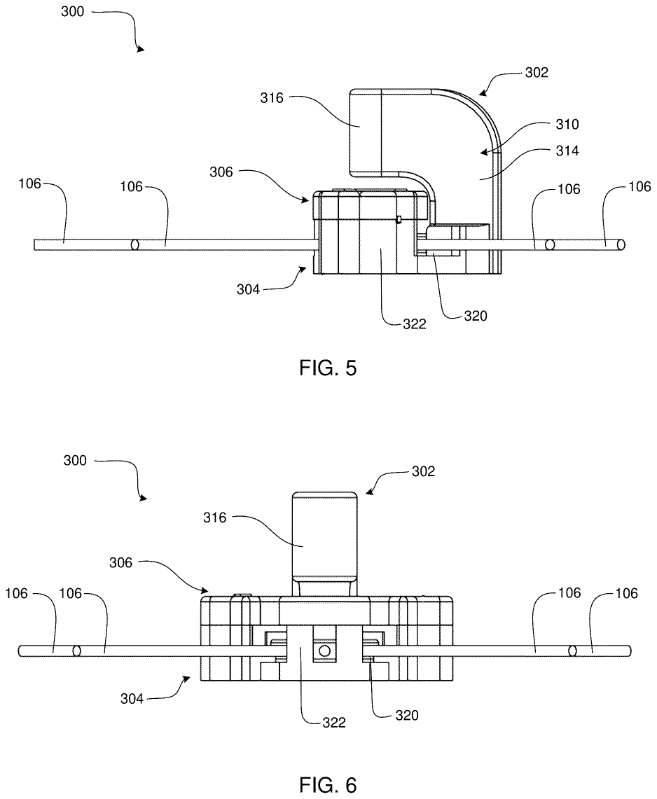

FIGS. 5 and 6 are straight-on side view of the coupler 300 that enables a user to convert a lampshade into a hanging light fixture, and further enables the user to exchange a lampshade of a light fixture without disassembling electrical components of the light fixture. Like the view shown in FIG. 4, the views in FIGS. 5 and 6 also components of a fitter (see 106 at FIG. 1) of a lampshade (see 104 at FIG. 1) installed within the coupler 300.

As shown in FIGS. 5 and 6, the spider rod channels 320 provide a negative space enabling a spider rod of a fitter 106 to rest within the base 304 of the coupler 300, and extend outward relative to the base sidewall 322. The spider rod channels 320 ensure the fitter 106 is installed securely and will not twist or rotate during regular use.

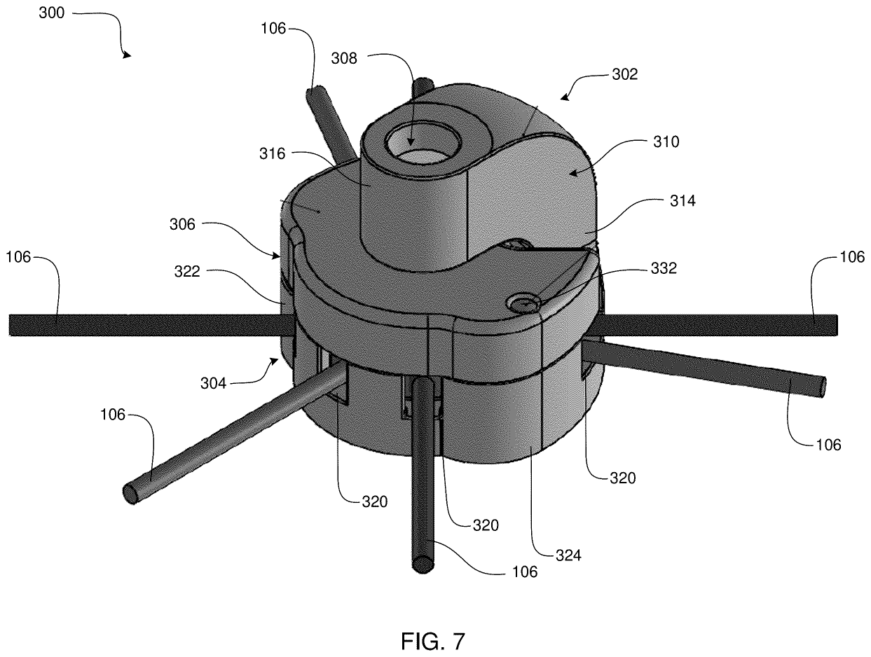

FIG. 7 is a perspective view of the coupler 300 that enables a user to convert a lampshade into a hanging light fixture, and further enables the user to exchange a lampshade of a light fixture without disassembling electrical components of the light fixture. In FIG. 7, the wedge 306 is swung into position such that the wedge 306 is disposed in between the base 304 and the conduit arm 302. In contrast with the view illustrated in FIG. 3, the view in FIG. 4 additionally illustrates components of a fitter (see 106 at FIG. 1) of a lampshade (see 104 at FIG. 1).

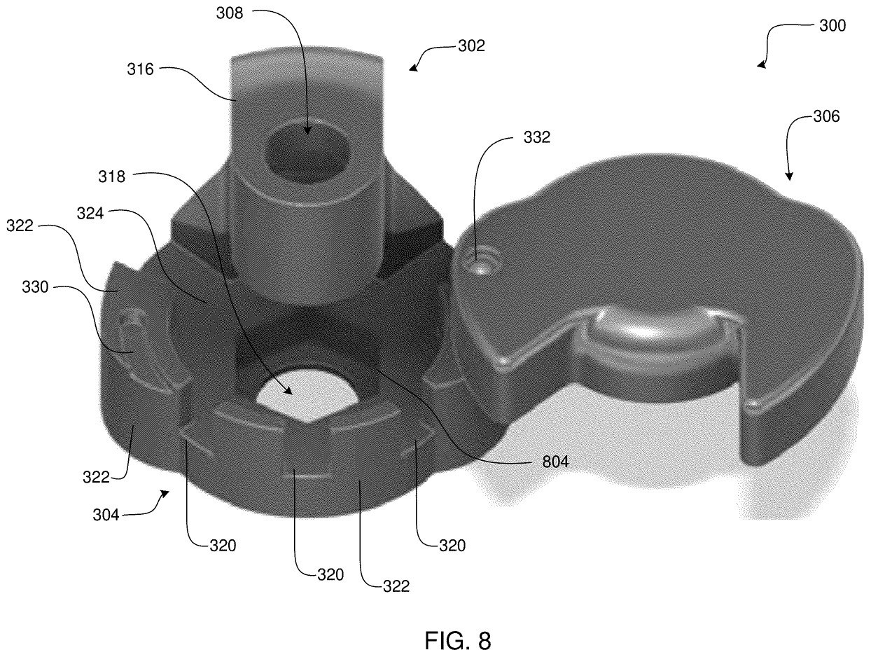

FIG. 8 is a perspective view of an implementation of the coupler 300 that enables a user to convert a lampshade into a hanging light fixture, and further enables the user to exchange a lampshade of a light fixture without disassembling electrical components of the light fixture. In FIG. 8, the wedge 306 is swung out of position such that the wedge 306 is coupled to the base 304 by way of the pivot point 332, but the wedge 306 is not disposed in between the base 304 and the conduit arm 302. into position such that the wedge 306 is disposed in between the base 304 and the conduit arm 302.

The base platform 324 may include a polygonal interface 804 comprising a plurality of sides. The polygonal interface 804 may include a hexagonal interface as shown in FIG. 4. The polygonal interface 804 may include, for example, a quadrilateral geometry, a pentagonal geometry, a hexagonal geometry, an octagonal geometry, and so forth. The polygonal interface 804 may include a recess formed within the base platform 324. This polygonal interface 804 recess may be configured to receive a nut having a corresponding polygonal geometry, and the nut may be utilized to fasten the coupler 300 to a lighting component, such as a light socket 110 or another light fixture component 108.

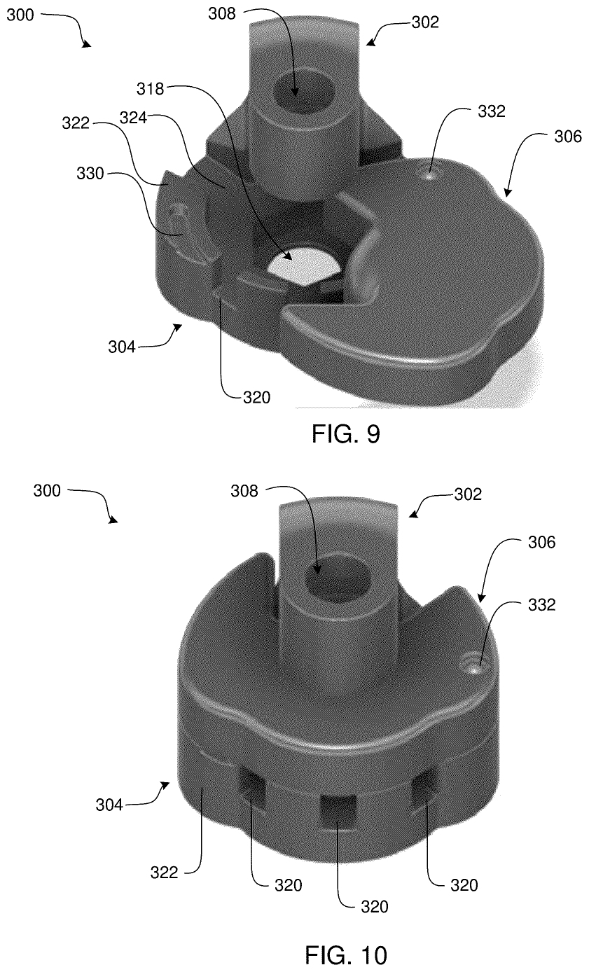

FIG. 9 is a perspective view of the coupler 300 that enables a user to exchange a lampshade of a light fixture without disassembling electrical components of the light fixture. In FIG. 9, the wedge 306 is partially swung outward relative to the conduit arm 302.

FIG. 10 is a perspective view of the coupler 300 that enables a user to exchange a lampshade of a light fixture without disassembling electrical components of the light fixture. In FIG. 10, the wedge 306 is fully swung inward such that the wedge 306 is disposed in between the base 304 and the conduit arm 302. The coupler 300 is disposed in the orientation shown in FIG. 10 when the coupler 300 is installed within a light fixture.

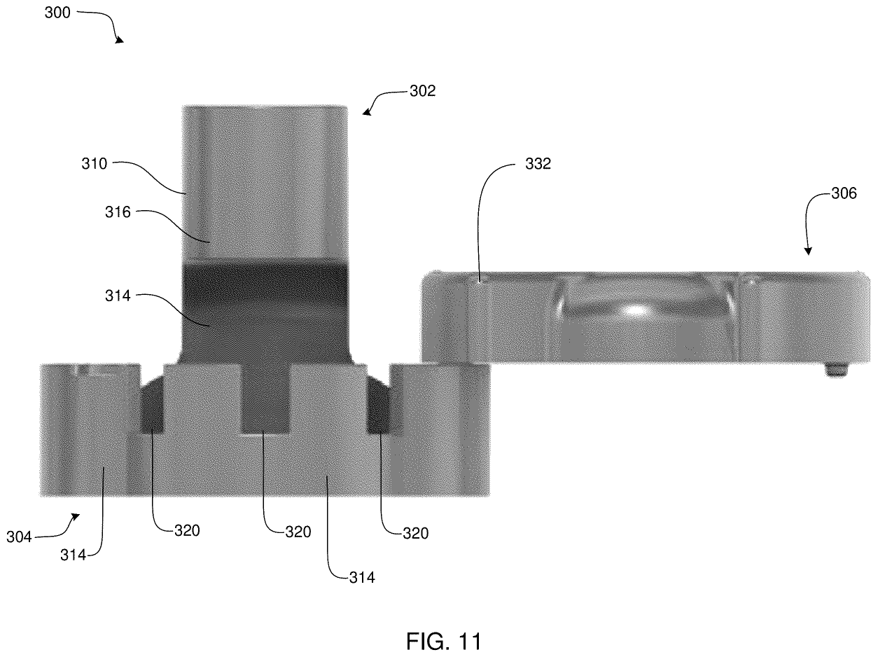

FIG. 11 is a straight-on side view of the coupler 300 that enables a user to exchange a lampshade of a light fixture without disassembling electrical components of the light fixture. In FIG. 11, the wedge 306 is fully swung outward relative to the conduit arm 302. The coupler 300 may be temporarily disposed in the orientation shown in FIG. 11 when the coupler 300 is installed within a light fixture.

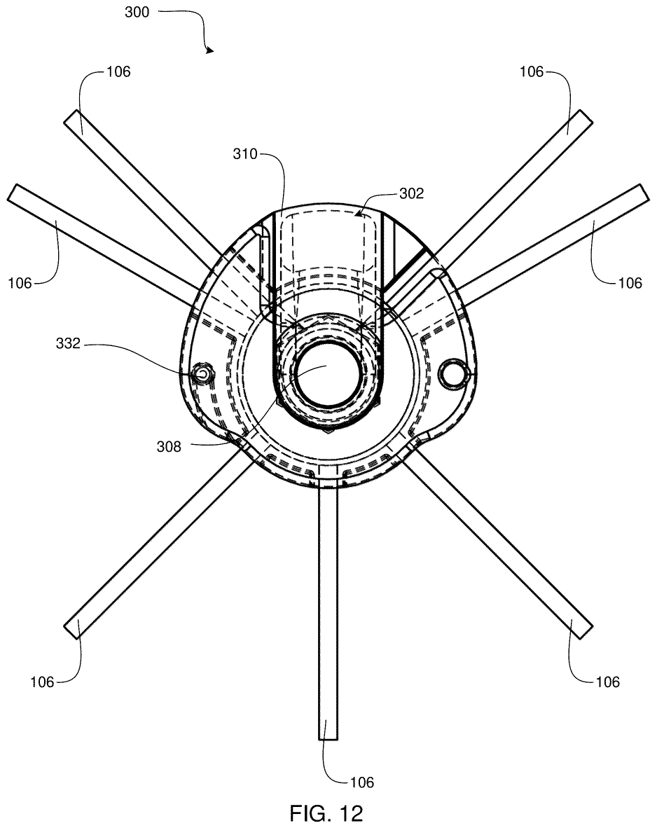

FIG. 12 is a wireframe aerial top-down view of the coupler 300 that enables a user to exchange a lampshade of a light fixture without disassembling electrical components of the light fixture. The dotted lines in FIG. 12 illustrate the hollow interior defined by the sidewall 310 of the conduit arm 302. The view in FIG. 12 further illustrates where spider rods of a fitter 106 of a lampshade 104 may rest within the coupler 300.

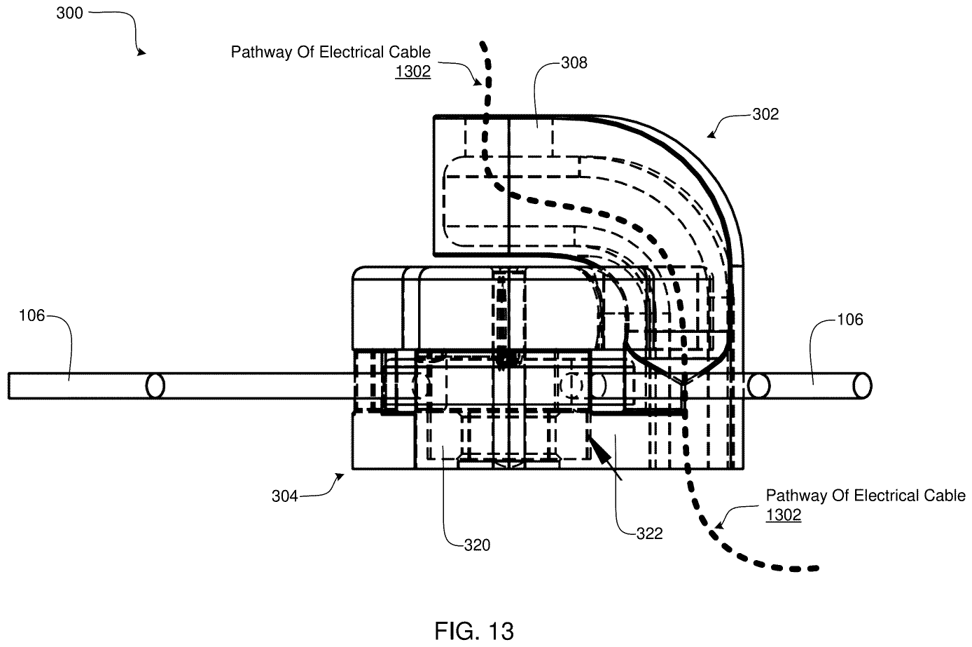

FIG. 13 is a wireframe straight-on side view of the coupler 300 that enables a user to exchange a lampshade of a light fixture without disassembling electrical components of the light fixture. The dotted lines in FIG. 13 illustrate the hollow interior defined by the sidewall 310 of the conduit arm 302. The view in FIG. 13 further illustrates where spider rods of a fitter 106 of a lampshade 104 may rest within the coupler 300.

FIG. 13 further illustrates the pathway of the electrical cable 1302 as it passes through the conduit arm 302. As shown in FIG. 13, the electrical cable may be fed through the hollow conduit arm 302 such that the electrical cable bypasses the center of the fitter 106 of the lampshade (see 104 at FIG. 1). This enables a user to exchange the lampshade quickly and easily without adjusting the electrical components of the light fixture.

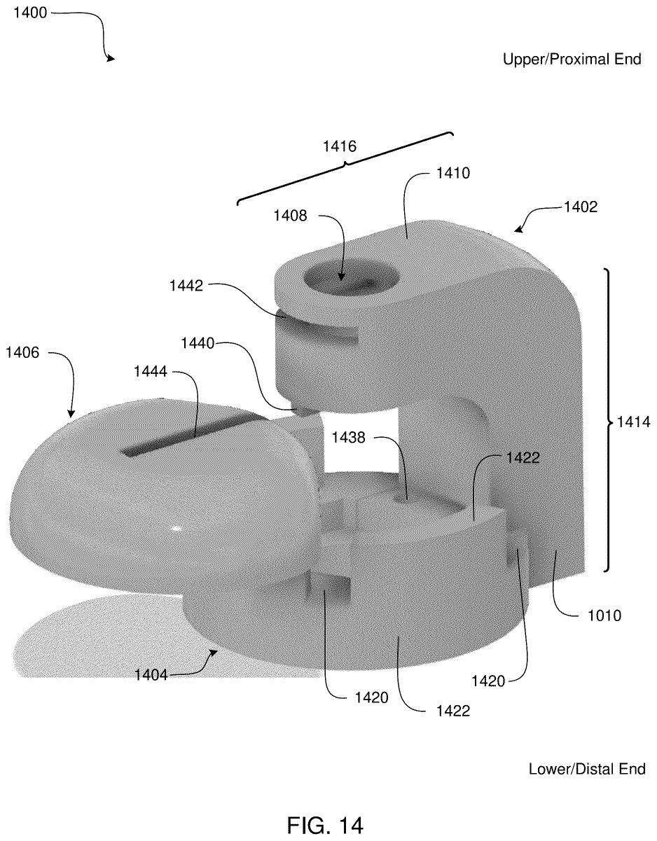

FIG. 14 is a perspective view of a coupler 1400 for coupling a lampshade to a light fixture without disassembling electrical components of the light fixture. The coupler 1400 includes a conduit arm 1402 coupled to a base 1404, and further includes a wedge 1406. The coupler 1400 may be utilized in connection with the light fixture 100 first described in connection with FIG. 1.

The coupler 1400 includes the conduit arm 1402 coupled to the base 1404. The coupler 1400 additionally includes the wedge 1406 configured to be disposed in between the conduit arm 1402 and the base 1404. The conduit arm 1402 and the base 1404 may be releasably coupled to one another or may be permanently fastened to one another as shown in FIG. 14. Alternatively, the conduit arm 1402 and the base 1404 may form a single indivisible element.

The conduit arm 1402 includes a sidewall 1410 that defines a hollow interior. The sidewall 1410 includes a conduit vertical sidewall 1414 and a conduit bend sidewall 1416. The conduit bend sidewall 1416 is attached to the conduit vertical sidewall 1414. The conduit bend sidewall 1416 may be oriented perpendicular relative to the conduit vertical sidewall 1414 within a tolerance of about ten percent, or within a tolerance from about one percent to about 20 percent. The hollow interior defined by the sidewall 1410 of the conduit arm 202 is configured to receive the electrical wire (see 114 at FIG. 1) of a light fixture (see 100 at FIG. 1).

The conduit arm 1402 includes an upper hole 1408 disposed through the conduit bend sidewall 1416. The upper hole 1408 is located on an upper side of the sidewall 1410 of the conduit arm 1402 when the coupler 1400 is installed within the light fixture 100. The conduit arm 1402 additionally includes a lower hole (not visible in FIG. 14, see, e.g., lower hole 226 at FIG. 2) formed by the sidewall 1410 of the conduit arm 1402. The hollow interior defined by the sidewall 1410 of the conduit arm 1402 extends at least from the upper hole 1408 to the lower hole (not visible). This enables a user to feed the electrical wire (see 114 at FIG. 1) into the hollow interior of the conduit arm 1402 through the upper hole 1408 and out through the lower hole, or vice versa.

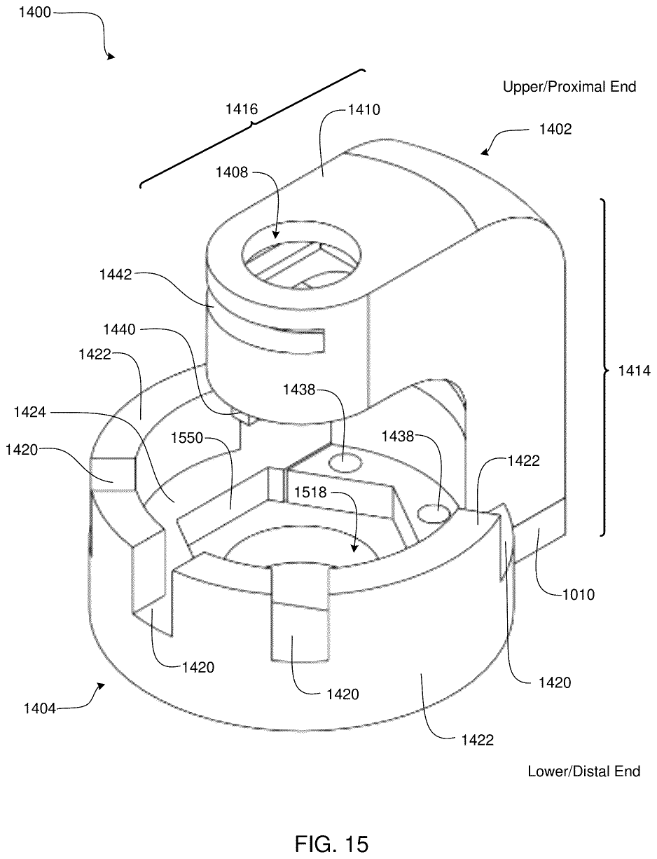

The base 1404 includes a base sidewall 1422 attached to a base platform (not visible in FIG. 14, see, e.g., base platform 1424 at FIG. 15). The base sidewall 1422 comprises a plurality of spider rod channels 1420 formed into an upper ridge of the base sidewall 1422. Each of the plurality of spider rod channels 1420 is configured to receive a spider rod of a fitter (see 106 at FIG. 1) of a lampshade 104.

The conduit arm 1402 includes an elongated hole 1442 formed in the sidewall 1410 of the conduit arm 1402. The elongated hole 1442 is oriented substantially perpendicular to a longitudinal axis of the conduit vertical sidewall 1414 of the conduit arm 1402. The elongated hole 1442 is configured to receive hardware for fastening the system 1400 to a light fixture 100. The elongated hole 1442 may specifically be configured to receive a nut, such that the nut may be pushed through the elongated hole 1442 and into the hollow interior space defined by the sidewall 1410 of the conduit arm 1402.

The conduit arm 1402 includes a ridge 1440 extending outward relative to the sidewall of the conduit arm 202. The ridge 1440 is configured to interface with a corresponding channel 1444 of the wedge 1406. A user may install the wedge 1406 by pressing the wedge 1406 in between the conduit arm 1402 and the base 1404 such that the channel 1444 of the wedge 1406 receives the ridge 1440 of the conduit arm 1402. This prevents the wedge 1406 from rotating and ensures the wedge 1406 is installed with correct alignment.

The base 1404 may include one or more coupling interfaces 1438 disposed within one or more of the base sidewall 1422 or a base platform of the base 1404. The one or more coupling interfaces 1438 may provide a means to releasably attach the conduit arm 1402 to the base 1404. The conduit arm 1402 may be releasably attached to the base 1404 by screwing a fastener into the coupling interface 1438 of the base 1404 and further into an aligned coupling interface (not visible in FIG. 14) of the conduit arm 1402.

FIG. 15 is a perspective view of the coupler 1400 for coupling a lampshade to a light fixture without disassembling electrical components of the light fixture. The view in FIG. 15 enables viewing of the base platform 1424, a through-hole 1518 of the base 1404, and the polygonal interface 1550 of the base 1404.

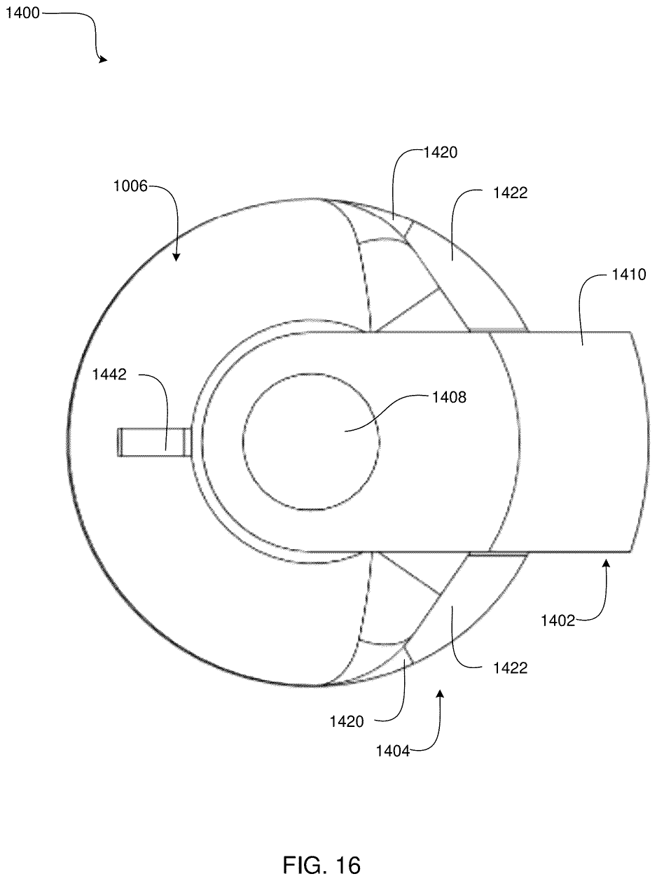

FIG. 16 is an aerial top-down view of the coupler 1400 that enables a user to exchange a lampshade of a light fixture without disassembling electrical components of the light fixture. The view in FIG. 16 illustrates wherein the wedge 1406 is installed in between the base 1404 and the conduit arm 1402 of the coupler 1400.

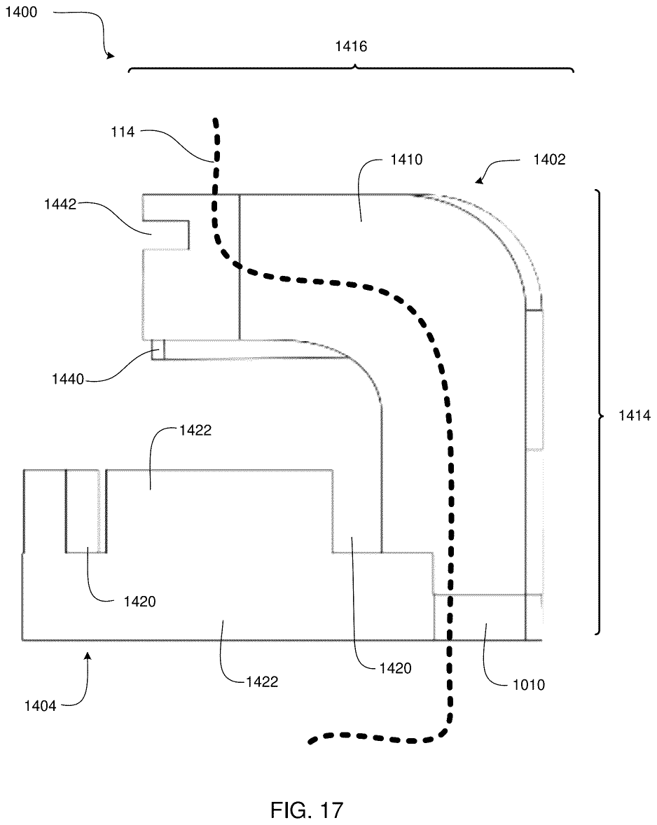

FIG. 17 is a straight-on side view of the coupler 1400 that enables a user to exchange a lampshade of a light fixture without disassembling electrical components of the light fixture. The wedge (see 1406) is not shown in the view of FIG. 17. FIG. 17 additionally provides a schematic view of an electrical wire 114 passing through the hollow interior defined by the sidewall 1410 of the conduit arm 1402.

As shown in FIG. 17, the electrical wire 114 may enter conduit arm 1402 through an upper hole (see 1408) formed through an upper surface of the conduit bend sidewall 1416. The electrical wire 114 may then pass through the hollow interior defined by the conduit bend sidewall 1416. The electrical wire 114 may then pass through the hollow interior defined by the conduit vertical sidewall 1414. The electrical wire 114 may then exit the conduit arm 1402 through a lower hole (not visible, see, e.g., lower hole 226 at FIG. 2) formed by the conduit vertical sidewall 1414. After the electrical wire 114 exits the conduit arm 1402, the electrical wire 114 may be fed into a lighting component, such as a light socket 110 or another light fixture component 108.

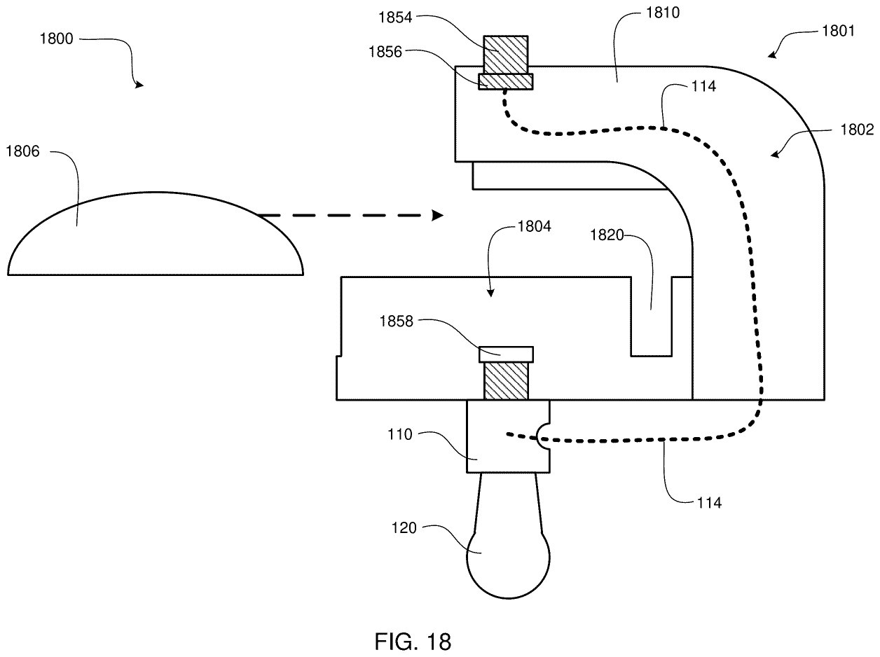

FIG. 18 is a schematic illustration of a system 1800 for exchanging a lampshade of a light 100 fixture without disassembling electrical components of the light fixture 100. The system 1800 includes a coupler 1801 that includes coupler features as described herein. The coupler 1801 may include components described in connection with either of the coupler 300 first described in connection with FIG. 3, or the coupler 1000 first described in connection with FIG. 10. The system 1800 additionally includes fastening components for fastening the coupler to a hanging mount (see 112 at FIG. 1) and a lighting component, such as a light socket 110 or another light fixture component 108.

The system 1800 includes a lightbulb 120 installed into a light socket 110. Although not shown in FIG. 18, the system 1800 may additionally include another light fixture component 108 such as a cluster body, and the light socket 110 may be installed into the cluster body. The system 1800 includes a nipple 1854 and nut 1856 configured to fasten a conduit arm 1802 of the coupler 1800 to a hanging mount 112. The electrical wire 114 may be received from the hanging mount 112 and installed through an upper hole 1808 of a conduit arm 1802 of the coupler 1801. The system 1800 includes a fastener 1858 that may comprise a polygonal head configured to interface with the polygonal interfaced formed within the base platform of the base 1804 of the coupler 1801. The fastener 1858 fastens the base 1804 of the coupler 1801 to the light socket 110 (or another lighting component such as a cluster body).

As shown in FIG. 18, the electrical wire 114 passes through the conduit arm 1802 of the coupler 1801, and then exits the conduit arm 1802 prior to entering the light socket 110 or other lighting component. This ensures the electrical wire 114 is not entangled within the lampshade 104 and thus bypasses the lampshade 104. This enables a user to quickly remove the lampshade 104 without fully disassembling the light fixture 100 or disconnecting electrical components for the light fixture 100.

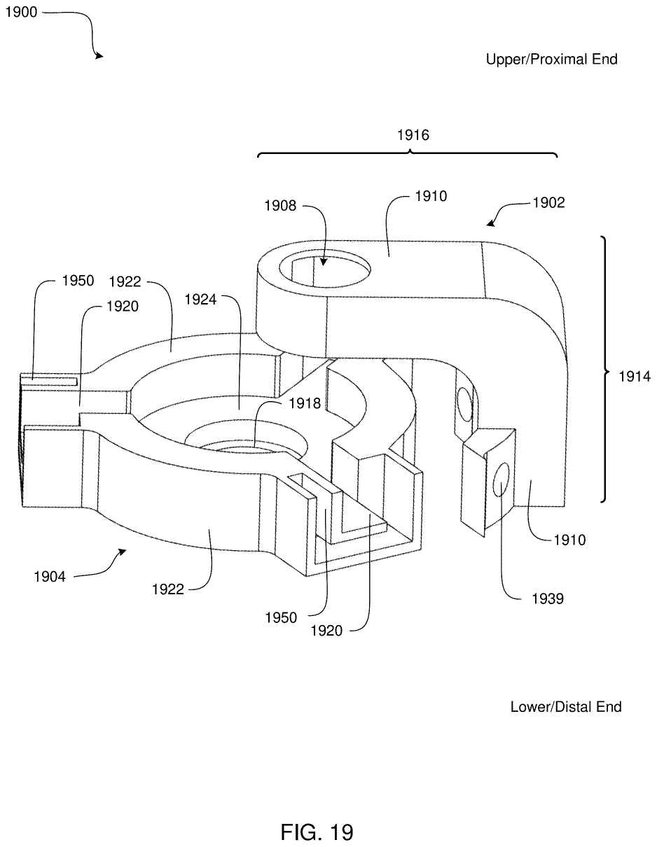

FIG. 19 is a perspective view of a coupler 1900 that enables a user to exchange a lampshade of a light fixture without disassembling electrical components of the light fixture. The coupler 1900 may be utilized in connection with the light fixture 100 first described in connection with FIG. 1, such that the coupler 1900 is like the coupler 102 illustrated in FIGS. 1 and 2.

The coupler 1900 includes a conduit arm 1902 coupled to a base 1904. The conduit arm 1902 and the base 1904 may be releasably coupled to one another. In alternative implementations, the conduit arm 1902 and the base 1904 may form a singular indivisible component or may be permanently fastened to one another.

The conduit arm 1902 includes a sidewall 1910 that defines a hollow interior. The sidewall 1910 includes a conduit vertical sidewall 1914 and a conduit bend sidewall 1916. The conduit bend sidewall 1916 is attached to the conduit vertical sidewall 1914 and may be oriented perpendicular to the vertical stem within a tolerance of about ten percent, or within a tolerance from about one percent to about 20 percent. The hollow interior defined by the sidewall 1910 of the conduit arm 202 is configured to receive the electrical wire (see 114 at FIG. 1) of a light fixture (see 100 at FIG. 1).

The conduit arm 1902 includes an upper hole 1908 disposed through the conduit bend sidewall 1916. The upper hole 1910 is located on an upper side of the sidewall 1910 of the conduit arm 1902 when the coupler 1900 is installed within the light fixture 100. The conduit arm 1902 additionally includes a lower hole (not visible in FIG. 19, see, e.g., lower hole 226 at FIG. 2) formed by the sidewall 1910 of the conduit arm 1902. The hollow interior defined by the sidewall 1910 of the conduit arm 1902 extends at least from the upper hole 1908 to the lower hole (not visible). This enables a user to feed the electrical wire (see 114 at FIG. 1) into the hollow interior of the conduit arm 1902 through the upper hole 1908 and out through the lower hole.

The base 1904 includes a base sidewall 1922 attached to a base platform 1924. The base sidewall 1922 comprises a plurality of spider rod channels 1920 formed cutting into an upper ridge of the base sidewall 1922. Each of the plurality of spider rod channels 1920 is configured to receive a spider rod of a fitter (see 106 at FIG. 1) of a lampshade 104.

The conduit arm 1902 may include one or more coupling interfaces 1939 formed within wings attached to the conduit vertical sidewall 1914. The one or more coupling interfaces 1939 may provide a means to releasably attach the conduit arm 1902 to the base 1904. The conduit arm 1902 may be releasably attached to the base 1904 by screwing a fastener into the coupling interface 1939 of the conduit arm 1902 and further into an aligned coupling interface (not visible in FIG. 19) of the base 1904.

The coupler 1900 differs from the coupler 300 (see FIGS. 3-7) because the coupler 1900 includes a plurality of interface channels 1950 formed within the spider rod channels 1920. The interface channels 1950 includes a hollow channel that may receive a chain, hook, or other fastener of a lampshade 104. This may be particularly useful if the lampshade 104 includes one or more chains for securing the lampshade 104 to the hanging mount 112.

The coupler 1900 further differs from the coupler 300 because the portion of the base sidewall 1922 that comprises the spider rod channels 1920 may extend outward relative to the base platform 1924, as shown in FIG. 19.

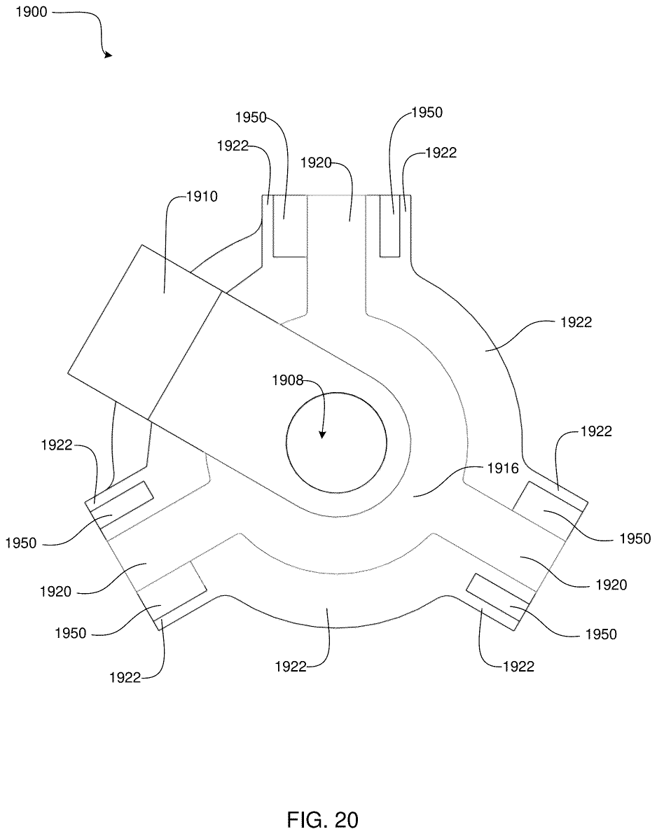

FIG. 20 is an aerial top-down view of the coupler 1900 that enables a user to exchange a lampshade of a light fixture without disassembling electrical components of the light fixture. The view in FIG. 20 illustrates wherein the interface channels 1950 may be accessed from either side of the spider rod channels 1920. As shown in FIGS. 19 and 20, the spider rod channels 1920 of the coupler 1900 may include a hovering platform that hovers above the interface channels 1950. A chain or other fastener for attaching a lampshade 104 to a hanging mount 112 may be inserted into the interface channels 1950 and hooked on to the hovering platform that forms the spider rod channels 1920.

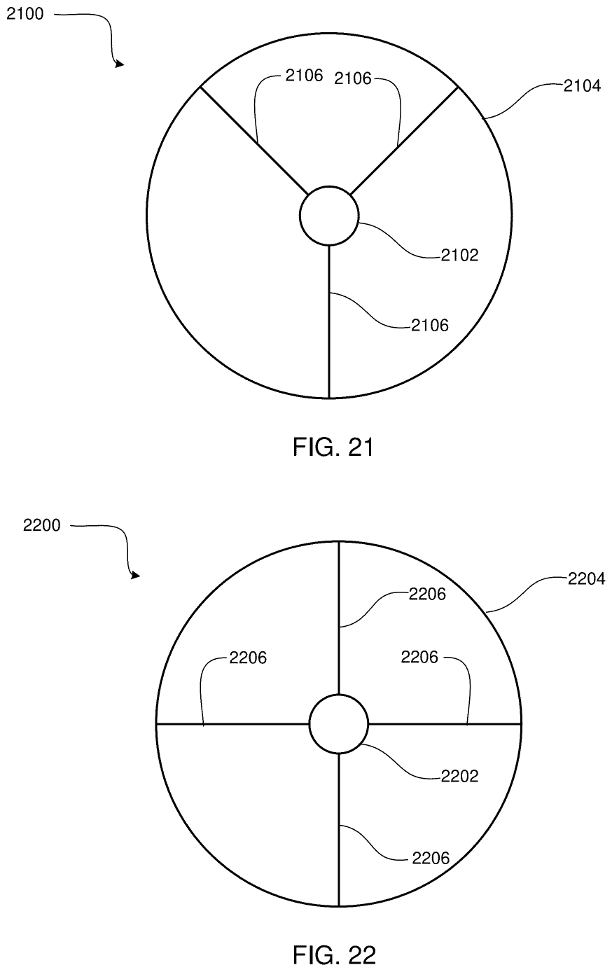

FIG. 21 is a schematic illustration of an aerial top-down view of a spider fitter 2100 of a lampshade. The spider fitter 2100 includes a central ring 2102 and an outer ring 2104. The spider fitter 2100 includes three spider rods 2106 connecting the central ring 2102 to the outer ring 2104.

FIG. 22 is a schematic illustration of an aerial top-down view of a spider fitter 2200 of a lampshade. The spider fitter 2200 includes a central ring 2202 and an outer ring 2204. The spider fitter 2200 includes three spider rods 2206 connecting the central ring 2202 to the outer ring 2204.

The couplers described herein may be utilized in connection with either of the spider fitters 2100, 2200 illustrated in FIGS. 21 and 22. The couplers may include three, four, or more spider rod channels to accommodate the spider rods of the spider fitters. Examples

The following examples pertain to further embodiments.

Example 1 is a device. The device includes a base comprising: a base platform; a base sidewall attached to the base platform, wherein the base sidewall is perpendicular to the base platform within a tolerance of ten percent; and a spider rod channel formed in the base sidewall, wherein the spider rod channel defines a negative space configured to receive a spider rod of a spider fitter of a lampshade. The device includes a conduit arm attached to the base, wherein the conduit arm comprises a conduit sidewall defining a hollow interior. The device is such that the hollow interior of the conduit arm is configured to receive an electrical wire of a light fixture.

Example 2 is a device as in Example 1, wherein the base comprises a through-hole disposed through the base platform; wherein the through-hole of the base is configured to receive a fastener for coupling the base to a lighting component; and wherein the lighting component comprises a light socket or a cluster body.

Example 3 is a device as in Examples 1-2, wherein the electrical wire of the light fixture is disposed through the hollow interior of the conduit arm such that the lampshade is removable without disconnecting the electrical wire from the lighting component.

Example 4 is a device as in Examples 1-3, wherein the conduit sidewall of the conduit arm comprises: a conduit vertical sidewall; and a conduit bend sidewall attached to the conduit vertical sidewall; wherein the hollow interior of the conduit arm extends through each of the conduit vertical sidewall and the conduit bend to form a bent hollow interior.

Example 5 is a device as in Examples 1-4, wherein at least a portion of the conduit bend sidewall is perpendicular to at least a portion of the conduit vertical sidewall within a tolerance of ten percent; and wherein the conduit vertical sidewall is disposed adjacent to the base sidewall such that at least a portion of the conduit vertical sidewall is parallel to the base sidewall within a tolerance of ten percent.

Example 6 is a device as in Examples 1-5, wherein the conduit bend sidewall comprises an upper hole disposed therethrough; wherein the upper hole is configured to receive the electrical wire of the light fixture; and wherein the conduit bend sidewall is configured to be fastened to a hanging mount of the light fixture that comprises one or more of a down-rod, stem, chain, rope, or cord.

Example 7 is a device as in Examples 1-6, wherein the conduit vertical sidewall forms the hollow interior such that a lower end of the conduit vertical sidewall forms a lower hole; wherein the lower hole is configured to receive the electrical wire such that the electrical wire passes through each of the upper hole, the bent hollow interior, and the lower hole.

Example 8 is a device as in Examples 1-7, wherein the base is configured to be fastened to a lighting component comprising one of a light socket or a cluster body; wherein the electrical wire enters the conduit arm via the upper hole and exits the conduit arm via the lower hole; wherein the electrical wire enters the lighting component to provide electricity to a light bulb of the light fixture; and wherein the electrical wire bypasses the base such that the lampshade of the light fixture is removable without disconnecting the electrical wire from the lighting component.

Example 9 is a device as in Examples 1-8, wherein the base comprises six spider rod channels formed in the base sidewall, and wherein the six spider rod channels are spaced apart relative to one another such that the base interfaces with either of a three-way spider fitter or a four-way spider fitter.

Example 10 is a device as in Examples 1-9, wherein the base comprises four spider rod channels formed in the base sidewall to interface with four spider rods of the spider fitter of the lampshade; wherein each of the four spider rod channels comprises a width optimized to receive one spider rod of the four spider rods of the spider fitter.

Example 11 is a device as in Examples 1-10, wherein the base comprises three spider rod channels formed in the base sidewall to interface with three spider rods of the spider fitter of the lampshade; wherein each of the three spider rod channels comprises a width optimized to receive one spider rod of the three spider rods of the spider fitter.

Example 12 is a device as in Examples 1-11, further comprising a wedge configured to be disposed in between the base and the conduit arm when the conduit arm is attached to the base, wherein the wedge prevents the lampshade from falling out of the base.

Example 13 is a device as in Examples 1-12, wherein the conduit sidewall of the conduit arm comprises: a conduit vertical sidewall; and a conduit bend sidewall attached to the conduit vertical sidewall, wherein at least a portion of the conduit bend sidewall is perpendicular to at least a portion of the conduit vertical sidewall within a tolerance of ten percent; wherein the wedge comprises a channel disposed into a surface of the wedge; wherein the conduit arm comprises a ridge attached to an outer surface of the conduit bend sidewall; and wherein the channel of the wedge is configured to receive the ridge of the conduit arm when the wedge is slid in between the conduit arm and the base.

Example 14 is a device as in Examples 1-13, wherein the conduit sidewall of the conduit arm comprises: a conduit vertical sidewall; and a conduit bend sidewall attached to the conduit vertical sidewall; wherein a distance from an upper surface of the base sidewall to a lower surface of the conduit bend sidewall defines an arm extension length when the conduit arm is attached to the base; and wherein the arm extension length is greater than a height of a central ring of the spider fitter of the lampshade to enable a user to slide the central ring in between the base and the conduit arm to install the central ring on the base platform.

Example 15 is a device as in Examples 1-14, wherein the base further comprises a plurality of interface channels attached to the base sidewall, wherein the plurality of interface channels are configured to interface with a plurality of hanging mounts of the light fixture.

Example 16 is a device as in Examples 1-15, wherein the hollow interior of the conduit arm receives the electrical wire of the light fixture such that the electrical wire bypasses a central ring of the spider fitter of the lampshade.

Example 17 is a system. The system includes a lampshade comprising a spider fitter, wherein the spider fitter comprises a central ring, an outer ring, and a plurality of spider rods connecting the central ring to the outer ring. The system includes a coupler, wherein the coupler includes any of the components of any combination of any of the devices of any of Examples 1-16.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on its presentation in a common group without indications to the contrary. In addition, various embodiments and examples of the present disclosure may be referred to herein along with alternatives for the various components thereof. It is understood that such embodiments, examples, and alternatives are not to be construed as de facto equivalents of one another but are to be considered as separate and autonomous representations of the present disclosure.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive.

Those having skill in the art will appreciate that many changes may be made to the details of the above-described embodiments without departing from the underlying principles of the disclosure. The scope of the present disclosure should, therefore, be determined only by the following claims.

What is claimed is:

1. A device for coupling a lampshade to a light fixture, the device comprising:
a base comprising:
a base platform;
a base sidewall attached to the base platform, wherein the base sidewall is perpendicular to the base platform within a tolerance of ten percent; and
a spider rod channel formed in the base sidewall, wherein the spider rod channel defines a negative space configured to receive a spider rod of a spider fitting of a lampshade; and
a conduit arm attached to the base, wherein the conduit arm comprises a conduit sidewall defining a hollow interior;
wherein the hollow interior of the conduit arm is configured to receive an electrical wire of the light fixture.

2. The device of claim 1, wherein the base comprises a through-hole disposed through the base platform;
wherein the through-hole of the base is configured to receive a fastener for coupling the base to a lighting component; and
wherein the lighting component comprises a light socket or a cluster body.

3. The device of claim 2, wherein the electrical wire of the light fixture is disposed through the hollow interior of the conduit arm such that the lampshade is removable without disconnecting the electrical wire from the lighting component.

4. The device of claim 1, wherein the conduit sidewall of the conduit arm comprises:
a conduit vertical sidewall; and
a conduit bend sidewall attached to the conduit vertical sidewall;
wherein the hollow interior of the conduit arm extends through each of the conduit vertical sidewall and the conduit bend to form a bent hollow interior.

5. The device of claim 4, wherein at least a portion of the conduit bend sidewall is perpendicular to at least a portion of the conduit vertical sidewall within a tolerance of ten percent; and
wherein the conduit vertical sidewall is disposed adjacent to the base sidewall such that at least a portion of the conduit vertical sidewall is parallel to the base sidewall within a tolerance of ten percent.

6. The device of claim 4, wherein the conduit bend sidewall comprises an upper hole disposed therethrough;
wherein the upper hole is configured to receive the electrical wire of the light fixture; and
wherein the conduit bend sidewall is configured to be fastened to a hanging mount of the light fixture that comprises one or more of a down-rod, stem, chain, rope, or cord.

7. The device of claim 6, wherein the conduit vertical sidewall forms the hollow interior such that a lower end of the conduit vertical sidewall forms a lower hole;
wherein the lower hole is configured to receive the electrical wire such that the electrical wire passes through each of the upper hole, the bent hollow interior, and the lower hole.

8. The device of claim 7, wherein the base is configured to be fastened to a lighting component comprising one of a light socket or a cluster body;
wherein the electrical wire enters the conduit arm via the upper hole and exits the conduit arm via the lower hole;
wherein the electrical wire enters the lighting component to provide electricity to a light bulb of the light fixture; and
wherein the electrical wire bypasses the base such that the lampshade of the light fixture is removable without disconnecting the electrical wire from the lighting component.

9. The device of claim 1, wherein the base comprises six spider rod channels formed in the base sidewall, and wherein the six spider rod channels are space apart relative to one another such that the base interfaces with either of a three-way spider fitting or a four-way spider fitting.

10. The device of claim 1, wherein the base comprises four spider rod channels formed in the base sidewall to interface with four spider rods of the spider fitting of the lampshade;
wherein each of the four spider rod channels comprises a width optimized to receive one spider rod of the four spider rods of the spider fitting.

11. The device of claim 1, wherein the base comprises three spider rod channels formed in the base sidewall to interface with three spider rods of the spider fitting of the lampshade;
wherein each of the three spider rod channels comprises a width optimized to receive one spider rod of the three spider rods of the spider fitting.

12. The device of claim 1, further comprising a wedge configured to be disposed in between the base and the conduit arm when the conduit arm is attached to the base, wherein the wedge prevents the lampshade from falling out of the base.

13. The device of claim 12, wherein the conduit sidewall of the conduit arm comprises:
a conduit vertical sidewall; and
a conduit bend sidewall attached to the conduit vertical sidewall, wherein at least a portion of the conduit bend sidewall is perpendicular to at least a portion of the conduit vertical sidewall within a tolerance of ten percent;
wherein the wedge comprises a channel disposed into a surface of the wedge;
wherein the conduit arm comprises a ridge attached to an outer surface of the conduit bend sidewall; and
wherein the channel of the wedge is configured to receive the ridge of the conduit arm when the wedge is slid in between the conduit arm and the base.

14. The device of claim 1, wherein the conduit sidewall of the conduit arm comprises:
a conduit vertical sidewall; and
a conduit bend sidewall attached to the conduit vertical sidewall;
wherein a distance from an upper surface of the base sidewall to a lower surface of the conduit bend sidewall defines an arm extension length when the conduit arm is attached to the base; and
wherein the arm extension length is greater than a height of a central ring of the spider fitting of the lampshade to enable a user to slide the central ring in between the base and the conduit arm to install the central ring on the base platform.

15. The device of claim 1, wherein the base further comprises a plurality of interface channels attached to the base sidewall, wherein the plurality of interface channels are configured to interface with a plurality of hanging mounts of the light fixture.

16. The device of claim 1, wherein the hollow interior of the conduit arm receives the electrical wire of the light fixture such that the electrical wire bypasses a central ring of the spider fitting of the lampshade.

17. A system comprising:
a lampshade comprising a spider fitting, wherein the spider fitting comprises a central ring, an outer ring, and a plurality of spider rods connecting the central ring to the outer ring;
a coupler configured to couple the lampshade to a hanging mount of a light fixture, wherein the coupler comprises:
a base comprising:
a base platform;
a base sidewall attached to the base platform, wherein the base sidewall is perpendicular to the base platform within a tolerance of ten percent; and
a spider rod channel formed in the base sidewall, wherein the spider rod channel defines a negative space configured to receive one of the plurality of spider rods of the spider fitting of the lampshade; and
a conduit arm attached to the base, wherein the conduit arm comprises a conduit sidewall defining a hollow interior;
wherein the hollow interior of the conduit arm is configured to receive an electrical wire of the light fixture such that the electrical wire does not pass through the central ring of the lampshade.

18. The system of claim 17, wherein the base of the coupler comprises a through-hole disposed through the base platform;
wherein the through-hole of the base is configured to receive a fastener for coupling the base to a lighting component; and
wherein the lighting component comprises a light socket or a cluster body.

19. The system of claim 18, wherein the electrical wire of the light fixture is disposed through the hollow interior of the conduit arm such that the lampshade is removable without disconnecting the electrical wire from the lighting component.

20. The system of claim 18, wherein at least a portion of the conduit bend sidewall is perpendicular to at least a portion of the conduit vertical sidewall within a tolerance of ten percent;
wherein the conduit vertical sidewall is disposed adjacent to the base sidewall such that at least a portion of the conduit vertical sidewall is parallel to the base sidewall within a tolerance of ten percent;
wherein the conduit bend sidewall comprises an upper hole disposed therethrough;
wherein the upper hole is configured to receive the electrical wire of the light fixture; and
wherein the conduit bend sidewall is configured to be fastened to a hanging mount of the light fixture that comprises one or more of a down-rod, stem, chain, rope, or cord.
